(19) United States
(12) Patent Application Publication
(10) Pub. No.: US 2019/0250307 A1
(43) Pub. Date: Aug. 15, 2019

(54) CONTEXTUALIZED WEATHER SUMMARIZATION FOR A TARGET EVENT

(71) Applicant: International Business Machines Corporation, Armonk, NY (US)

(72) Inventors: Aaron K. Baughman, Silver Spring, MD (US); Jeff Amsterdam, Roswell, GA (US); Stephen C. Hammer, Marietta, GA (US)

(21) Appl. No.: 15/894,858

(22) Filed: Feb. 12, 2018

(51) Int. Cl. G01W 1/10

(52) U.S. Cl. CPC G01W 1/10; G01W 2001/006

(57) ABSTRACT

A method, system and computer program product for the contextualized weather summarization for a target event includes the receipt in memory of a computer of a weather report corresponding to a geographical locale corresponding to a particular event and venue for the event and the processing of the received weather report to generate a multiplicity of different contextual summarizations utilizing a pre-established weather grammar. Then, a processor of the computer analyzes each one of the different contextual summarizations to measure a tone ranging from negative to positive. Finally, the processor transmits a most positive measured one of the contextual summarizations over the computer communications network to end users seeking a weather forecast for the geographical locale corresponding to the particular event and venue for the event.

### BACKGROUND OF THE INVENTION

### Field of the Invention

The present invention relates to the field of weather data presentation and more particularly to the summarization of weather data.

### Description of the Related Art

Even prior to the advent of the global Internet, weather data had been one of the first types of data disseminated over public computer communications networks given the apparent value of simply knowing the weather for a particular locale. With the pervasive nature of Internet access today, weather data remains a premier type of data sourced by different individuals over the Internet—typically presented in a Web interface in a Web browser. Indeed, weather data now having been syndicated by many sources of weather data, other content providers about the Web embed weather data in content presented to end users over the Web.

The common end user remains able to access weather data responsive to a request for weather data for a specific location such as a city specified by name or zip code, or a geographic point of interest (POI) such as an airport or venue such as a stadium. Indeed, many sources of information present on the Web including some travel services or entertainment or sporting venues incorporate with other information, weather content pertinent to a particular day and location in connection with a specific context such as an airline flight or sporting event. While this information may be presented in a traditional weather display sorted by day and time, this manner of presenting weather data often lacks a contextual narrative which can help summarize and explain the forecast to the end user.

In this regard, at present weather forecast data may be acquired and presented in a detailed and structured format, but there remains absent the ability to summarize and present a weather forecast in a human readable and unstructured way. Through traditional weather information channels, a meteorologist might summarize forecast data in a narrative and present to the consumer for easier comprehension. The consumer can view the structured data and read or listen to the summarization for better contextual understanding. However, in more ubiquitous collection and distribution examples, there is no human element constructing this narrative for every geographic location or set of structured forecast data. This leaves interpretation of the numerical weather forecasts up to the consumers, and often lead to varying results. For different outlets, such as outdoor sporting events, the interpretation of the consumer is an important factor to determining attendance and success of the event. Accordingly, the organizers of these types of events have a responsibility to provide an accurate weather forecast, but the organizers also are incentivized to provide an accurately optimistic forecast or narrative if warranted by deeper interpretation of the data.

### BRIEF SUMMARY OF THE INVENTION

Embodiments of the present invention address deficiencies of the art in respect to contextual weather data presentation and provide a novel and non-obvious method, system and computer program product for the contextualized weather summarization for a target event. In an embodiment of the invention, a method for contextualized weather summarization for a target event includes the receipt in memory of a computer of a weather report corresponding to a geographical locale corresponding to a particular event and venue for the event and the processing of the received weather report to generate a multiplicity of different contextual summarizations utilizing a pre-established weather grammar. Then, a processor of the computer analyzes each one of the different contextual summarizations to measure a tone ranging from negative to positive. Finally, the processor transmits a most positive measured one of the contextual summarizations over the computer communications network to end users seeking a weather forecast for the geographical locale corresponding to the particular event and venue for the event.

In one aspect of the embodiment, the pre-established weather grammar is pre-established by receiving in memory of the computer from over the computer communications network, different annotations by different sources of annotations of different terms in different stored weather reports. Then, the processor scores each of the annotations based upon a corresponding one of the sources of the annotations and a computed probability of accuracy of the corresponding one of the sources. For instance, the computed probability of accuracy of the corresponding one of the sources may be determined as a function of a probability density function corresponding to the corresponding one of the sources, for instance, a beta distribution. Finally, the processor of the computer generates the weather grammar according to the annotations and the scores associated with the annotations.

In another aspect of the embodiment, the contextual summarizations each are created by repeatedly generating different sentences by correlating a pre-set number of a most prominently presented terms in the received weather report with words in the pre-established weather grammar and constructing the sentences with the correlated terms utilizing a natural language sentence generator. As well, in yet another aspect of the embodiment, the analysis of each one of the different contextual summarizations includes submitting each of the different contextual summarizations as an array of words to a neural network trained to return a determined tone of the array of words.

In another embodiment of the invention, a data processing system is adapted for contextualized weather summarization for a target event. The system includes a host computing system that has at least one computer with memory and at least one processor and a network adapter communicatively coupled to a computer communications network. The system also includes a data store coupled to the host computing system storing therein a weather grammar. The system yet further includes a Web server receiving requests from over the network from end users seeking weather data for a geographical locale corresponding to a particular event and venue for the event. Finally, the system includes a contextualized weather summarization module executing in the memory of the host computing system.

The module includes program instructions adapted to receive in the Web server a weather report corresponding to the geographical locale corresponding to a particular event and venue for the event and to process the received weather report to generate a multiplicity of different contextual summarizations utilizing a pre-established weather grammar. The program instructions additionally are adapted to analyze each one of the different contextual summarizations to measure a tone ranging from negative to positive. Finally, the program instructions are adapted to direct the Web server to transmit a most positive measured one of the contextual summarizations over the computer communications network to end users seeking a weather forecast for the geographical locale corresponding to the particular event and venue for the event.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for the contextualized weather summarization for a target event;

FIG. 2 is a schematic illustration of a data processing system adapted for contextualized weather summarization for a target event; and,

FIG. 3 is a flow chart illustrating a process for contextualized weather summarization for a target event.

### DETAILED DESCRIPTION OF THE INVENTION

Embodiments of the invention provide for contextualized weather summarization for a target event. In accordance with an embodiment of the invention, different weather reports are received from respectively different sources in respect to a particular event and venue for the event. The weather report from each different source is then annotated both in terms of named-entity and part of speech. The annotations are then scored based upon the source of the annotations and a corresponding computed probability of accuracy of the source. The resultant annotations are stored as a weather grammar in a database. Then, a contemporaneous weather report for a geographical locale corresponding to the particular event and venue for the event is received and the terms parsed and the most prominent terms in the weather report are identified. The prominent terms are then passed to a sentence generator in order to generate different sentences regarding the weather report. Optionally, different subsets of the sentences can be arranged into different paragraphs as respective contextual summarizations of the contemporaneous weather report, which each are then analyzed to measure a tone ranging from negative to positive. The most positive measured one of the contextual summarizations is then transmitted over a computer communications network to end users seeking a weather report for the geographical locale.

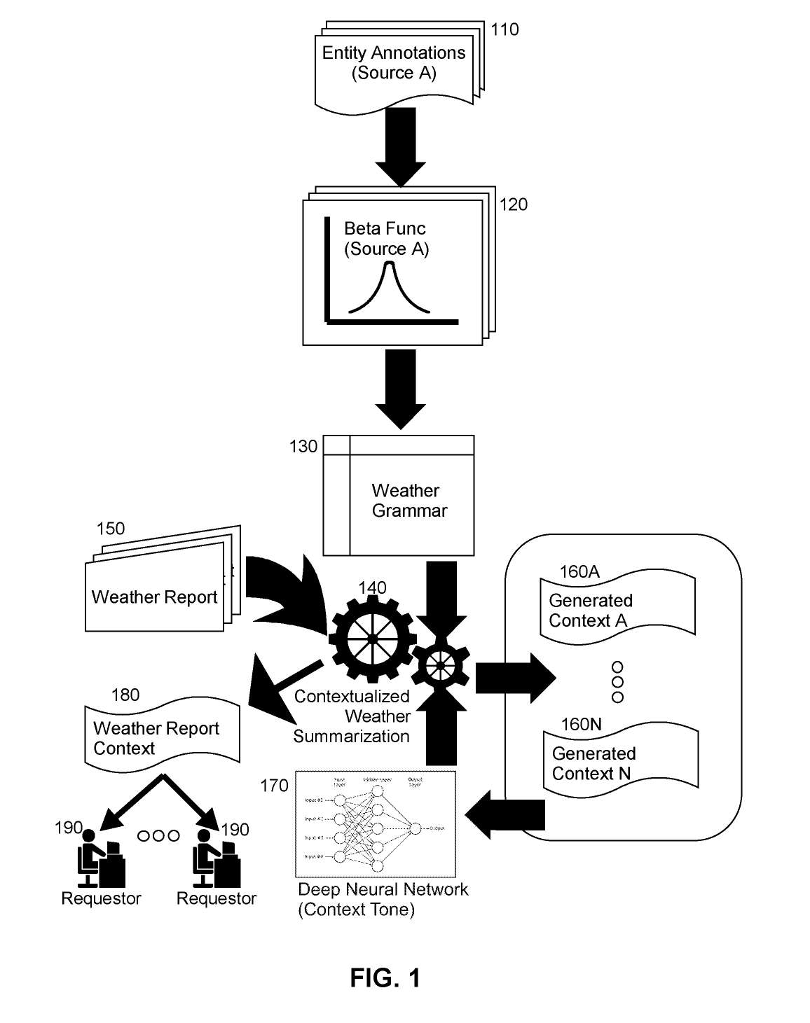

In further illustration, FIG. 1 pictorial shows a process for the contextualized weather summarization for a target event. As shown in FIG. 1, different entity and, optionally, part-of-speech annotations, are applied to different weather reports by different sources of the annotations. The sources of the annotations are identified and a probability density function 120 for each of the identified sources are used to determine a likelihood of accuracy of the annotations. A weather grammar 130 is then constructed from the annotations 110 accounting for the most accurate of the sources of the annotations 110, discarding or discounting those of the annotations 110 deemed less probable for accuracy while utilizing and in some cases emphasizing those of the annotations 110 deemed more reliable based upon corresponding probability density functions 120.

For instance, the corresponding probability density functions 120 can be computed as a beta function comparing past accurate annotations with past inaccurate annotations as a function of all annotations, accurate and inaccurate. In this way, a mean probability of a probable accurate annotation can be determined for each source in reference to a corresponding beta function. As well, the most probable annotations from different sources may be grouped together in the weather grammar as a merged set of words according to common probabilities of accuracy.

Once the weather grammar 130 has been constructed, contextualized weather summarization logic 140 responds to a request from a requester 190 for a weather report 150 for a particular geographic locale of an event by parsing the weather report 150 to identify the most prominently presented terms and to construct a multiplicity of sentences utilizing words in the weather grammar 130 corresponding to the terms. In this regard, a sentence generator configured for natural language processing may receive the words from the weather grammar 130 corresponding to the most prominently presented terms in the weather report 150 in order to generate different sentences. The sentences then may be arranged to form different contextual summarizations 160A, 160N of the weather report 150. Finally, the contextualized weather summarization logic 140 submits each of the contextual summarizations 160A, 160N as an array of words to a deep neural network 170 trained to indicate a tone of submitted arrays of words ranging from negative tone to positive tone. In consequence, the contextual weather summarization logic 140 selects amongst the contextual summarizations 160A, 160N, one of the contextual summarizations 160A, 160N determined by the deep neural network 170 to have the most positive tone and return the same as a weather report context 180 to the requestor 190.

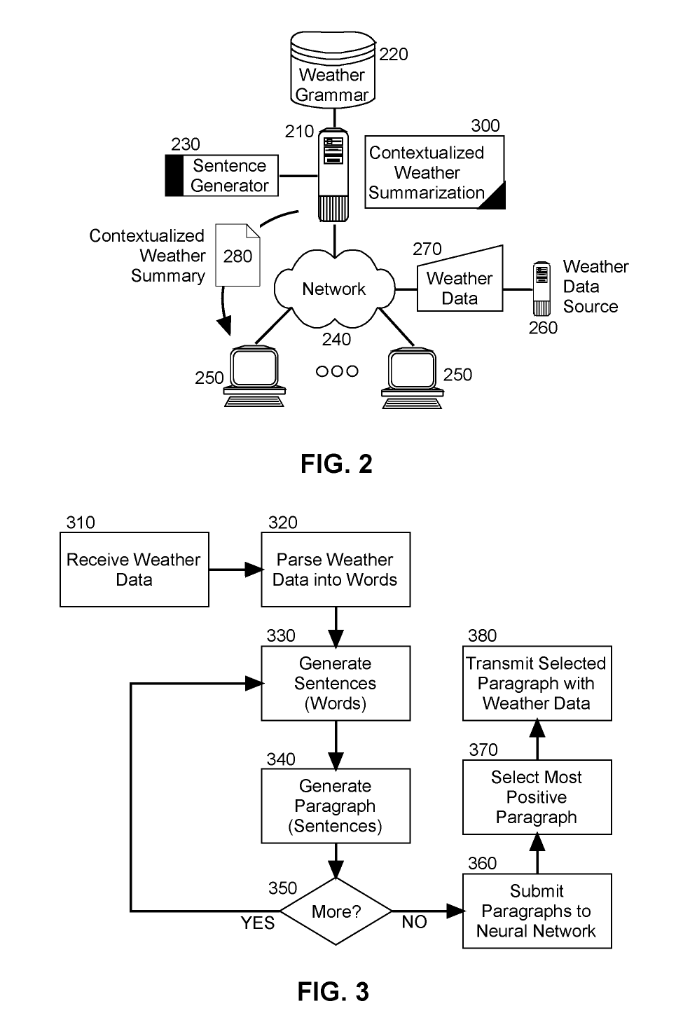

The process described in connection with FIG. 1 may be implemented in a data processing system. In further illustration, FIG. 2 schematically illustrates a data processing system adapted for contextualized weather summarization for a target event. The system includes a host computing system 210 that includes one or more computers, each with memory and at least one processor. The host computing system 210 is communicatively coupled over computer communications network 240 to different client computing devices 250, including personal computers, smartphone, laptop computers and tablet computing devices, to name only a few examples. A data store 220 is coupled the host computing system and stores therein a weather grammar produced in consequence of the entity and part-of-speech annotation by different individuals of different weather reports, with the probabilistic accuracy of each annotation accounted for in consideration of the content of the weather grammar.

Of note, the system includes a contextualized weather summarization module 300. The module 300 includes program instructions that execute in the memory of the host computing system 210. The program instructions are enabled during execution to respond to a request by a requesting one of the client computing devices 250 for a weather report for a particular locale associate with a venue for an event by receiving weather data 270 for the particular locale from a weather data source 260 from over computer communications network 240. The program instructions are further enabled during execution to utilize a sentence generator 230 also executing in the host computing system 210 in order to generate different sentences utilizing words in the weather grammar 220 corresponding to prominent terms in the weather data 270.

The program instructions yet further are enabled during execution to aggregate the generated sentences into different paragraphs, each representing a contextual summarization of the weather data 270. The program instructions even yet further are enabled during execution to select only one of the contextual summarizations computed to have the most positive tone. Finally, the program instructions are enabled during execution to return the selected contextual summarization as a contextualized weather summary to the requesting one of the client computing devices 250.

In even yet further illustration of the operation of the contextualized weather summarization module 300, FIG. 3 is a flow chart illustrating a process for contextualized weather summarization for a target event. Beginning in block 310, weather data is received for a particular geographical locale in connection with a request by a requestor for a weather report for an event at a venue within the particular geographical locale. In block 320, the weather data is parsed into component terms including words and numbers and a most visually prominently presented set of the terms are used in block 330 to retrieve from a weather grammar, different sets of words pertaining to the terms and to provide the different sets of words from the weather grammar to a sentence generator so as to generate a multiplicity of different sentences corresponding to the weather data. In block 340, the generated sentences are organized into a contextual summarization of the weather data.

In decision block 350, it can be determined if additional contextual summarizations are to be generated. If so, the process can repeat in block 330 with the retrieval from the weather grammar of different sets of words pertaining to the terms and the provision of the different sets of words from the weather grammar to a sentence generator so as to generate a multiplicity of different sentences corresponding to the weather data. In block 340, once again, the generated sentences are organized into a contextual summarization of the weather data. In block 350, when no further contextual summarizations are to be generated, in block 360, each of the contextual summarizations are submitted to a deep neural network as an array of words so as to received in return, an indication of the tone of the submitted contextual summarization in terms of a probability of positive tone. In block 370, then, the contextual summarization determined to have the highest probability of positive tone is selected and in block 380, the selected contextual summarization is transmitted as a summary of the weather data to the requestor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

We claim:

1. A method for contextualized weather summarization for a target event, the method comprising:
receiving in memory of a computer, a weather report corresponding to a geographical locale corresponding to a particular event and venue for the event;
processing the received weather report to generate a multiplicity of different contextual summarizations utilizing a pre-established weather grammar;
analyzing by the processor of the computer each one of the different contextual summarizations to measure a tone ranging from negative to positive;
transmitting a most positive measured one of the contextual summarizations over the computer communications network to end users seeking a weather forecast for the geographical locale corresponding to the particular event and venue for the event.

2. The method of claim 1, wherein the pre-established weather grammar is pre-established by:
receiving in memory of the computer from over the computer communications network, different annotations by different sources of annotations of different terms in different stored weather reports;
scoring by a processor of the computer each of the annotations based upon a corresponding one of the sources of the annotations and a computed probability of accuracy of the corresponding one of the sources; and,
generating the weather grammar according to the annotations and the scores associated with the annotations.

3. The method of claim 1, wherein the contextual summarizations each are created by repeatedly generating different sentences by correlating a pre-set number of a most prominently presented terms in the received weather report with words in the pre-established weather grammar and constructing the sentences with the correlated terms utilizing a natural language sentence generator.

4. The method of claim 2, wherein the computed probability of accuracy of the corresponding one of the sources is determined as a function of a probability density function corresponding to the corresponding one of the sources.

5. The method of claim 2, wherein the corresponding probability density function is a beta distribution.

6. The method of claim 1, the analysis of each one of the different contextual summarizations includes submitting each of the different contextual summarizations as an array of words to a neural network trained to return a determined tone of the array of words.

7. A data processing system adapted for contextualized weather summarization for a target event, the system comprising:
a host computing system comprising at least one computer with memory and at least one processor and a network adapter communicatively coupled to a computer communications network;
a data store coupled to the host computing system storing therein a weather grammar;
a Web server receiving requests from over the network from end users seeking weather data for a geographical locale corresponding to a particular event and venue for the event; and,
a contextualized weather summarization module executing in the memory of the host computing system and comprising program instructions adapted to perform:
receiving in the Web server a weather report corresponding to the geographical locale corresponding to a particular event and venue for the event;
processing the received weather report to generate a multiplicity of different contextual summarizations utilizing a pre-established weather grammar;
analyzing each one of the different contextual summarizations to measure a tone ranging from negative to positive;
directing the Web server to transmit a most positive measured one of the contextual summarizations over the computer communications network to end users seeking a weather forecast for the geographical locale corresponding to the particular event and venue for the event.

8. The system of claim 7, wherein the pre-established weather grammar is pre-established by:
receiving in memory of the computer from over the computer communications network, different annotations by different sources of annotations of different terms in different stored weather reports;
scoring by a processor of the computer each of the annotations based upon a corresponding one of the sources of the annotations and a computed probability of accuracy of the corresponding one of the sources; and,
generating the weather grammar according to the annotations and the scores associated with the annotations.

9. The system of claim 7, wherein the contextual summarizations each are created by repeatedly generating different sentences by correlating a pre-set number of a most prominently presented terms in the received weather report with words in the pre-established weather grammar and constructing the sentences with the correlated terms utilizing a natural language sentence generator.

10. The system of claim 8, wherein the computed probability of accuracy of the corresponding one of the sources is determined as a function of a probability density function corresponding to the corresponding one of the sources.

11. The system of claim 8, wherein the corresponding probability density function is a beta distribution.

12. The system of claim 7, the analysis of each one of the different contextual summarizations includes submitting each of the different contextual summarizations as an array of words to a neural network trained to return a determined tone of the array of words.

13. A computer program product for contextualized weather summarization for a target event, the computer program product comprising a computer readable storage medium having program instructions embodied therewith, wherein the computer readable storage medium is not a transitory signal per se, the program instructions executable by a device to cause the device to perform a method comprising:
receiving in memory of a computer, a weather report corresponding to a geographical locale corresponding to a particular event and venue for the event;
processing the received weather report to generate a multiplicity of different contextual summarizations utilizing a pre-established weather grammar;
analyzing by the processor of the computer each one of the different contextual summarizations to measure a tone ranging from negative to positive;
transmitting a most positive measured one of the contextual summarizations over the computer communications network to end users seeking a weather forecast for the geographical locale corresponding to the particular event and venue for the event.

14. The computer program product of claim 13, wherein the pre-established weather grammar is pre-established by:
receiving in memory of the computer from over the computer communications network, different annotations by different sources of annotations of different terms in different stored weather reports;
scoring by a processor of the computer each of the annotations based upon a corresponding one of the sources of the annotations and a computed probability of accuracy of the corresponding one of the sources; and,
generating the weather grammar according to the annotations and the scores associated with the annotations.

15. The computer program product of claim 13, wherein the contextual summarizations each are created by repeatedly generating different sentences by correlating a pre-set number of a most prominently presented terms in the received weather report with words in the pre-established weather grammar and constructing the sentences with the correlated terms utilizing a natural language sentence generator.

16. The computer program product of claim 14, wherein the computed probability of accuracy of the corresponding one of the sources is determined as a function of a probability density function corresponding to the corresponding one of the sources.

17. The computer program product of claim 14, wherein the corresponding probability density function is a beta distribution.

18. The computer program product of claim 13, the analysis of each one of the different contextual summarizations includes submitting each of the different contextual summarizations as an array of words to a neural network trained to return a determined tone of the array of words.
